(19) United States
(12) Patent Application Publication
(10) Pub. No.: US 2003/0159581 A1
(43) Pub. Date: Aug. 28, 2003

(54) Method and system for sea-based handling of hydrocarbons

(76) Inventors: Morten Sanderford, Randaberg (NO); Bernt Helge Torkildsen, Bergen (NO); Jens Grendstad, Mjondalen (NO); Egil Tveit, Woking, Surrey (GB); Olav Inderberg, Kongsberg (NO)

Correspondence Address: Andrus Sceales Starke & Sawall, 100 East Wisconsin Avenue, Suite 1100, Milwaukee, WI, 53202, US

(21) Appl. No.: 10/275,309

(22) PCT Filed: Apr. 27, 2001
(86) PCT No.: PCT/NO01/00178

(30) Foreign Application Priority Data
May 4, 2000 (NO) 20002356

(51) Int. Cl. B01D 19/00

(52) U.S. Cl. 95/243; 95/254; 96/215

(57) ABSTRACT

A method and system for sea-based handling/treatment of fluid hydrocarbons (oil) with associated gas comprise a first separation step in a high-pressure separator (18) installed on the sea bed, from which is output an oil flow containing an essentially predefined percentage of residual gas. The oil containing residual gas is carried through a riser (22) up to a surface vessel/production ship (12), where it is subjected to a second separation step in a second separator (24) incorporated in a low-pressure surface plant on board the vessel (12), this separated residual gas being used as fuel for direct/indirect generation of electric power for the operation of the underwater and above-water sections of the system. Water and gas produced in the first separation step is returned to a suitable reservoir by the use of a multiphase pump.

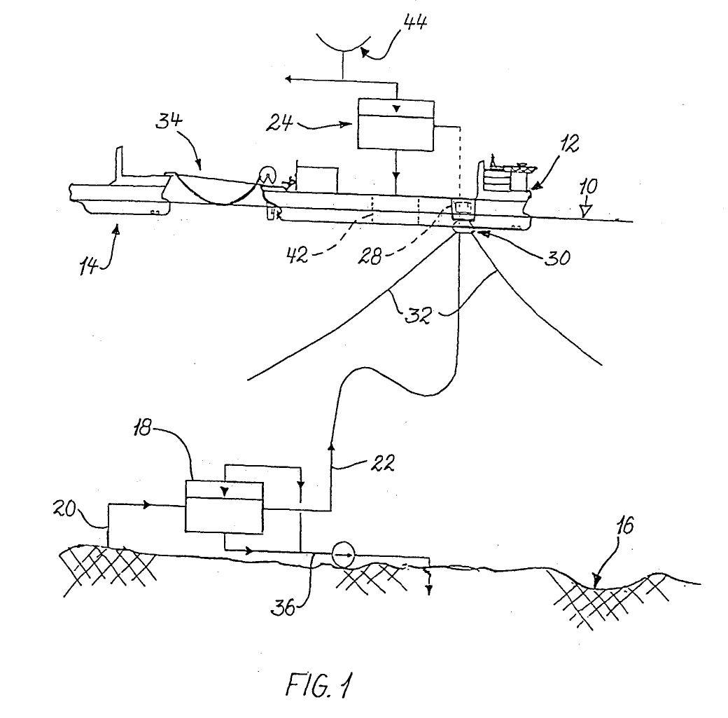

The present invention relates to a method and system including processing plant, for sea-based treatment/handling of fluid hydrocarbons with associated gas and possibly containing smaller amounts of water, wherein at least one hydrocarbon-separating operation is carried out on the sea bed, and fluid hydrocarbons are carried up to a surface vessel, a platform or other sea-based installation.

Known technique comprises systems both with and without separator for the separation of gas from oil on sea bed level.

Known systems of the relevant kind working without separator for oil and gas placed on the sea bed, comprise high-pressure processing plant on board ships (production ships) and sea-based platforms for the treating of oil with associated gas. Known plants of this kind are space- and equipment-demanding and thereby very expensive. A very important condition in such treatment of hydrocarbons in a surface position is that the handling of said associated gas has to take place under high pressure, which requires extensive safety measures. It is also a significant drawback in this kind of processing plants that in addition to being voluminous and thereby space-demanding, they are extremely heavy, so that ships/platforms arranged thereto must be sized in order to take up both the volume and the weight of the processing plant.

Such high investment costs are connected to these known sea-based processing plants, that smaller hydrocarbon-producing fields in isolated locations, have been exploited only to a minor extent.

Underwater production well heads for untreated well flow have been used together with high-pressure processing plants on ships or platforms. It is known to inject seawater into wells from sea bed level, and it is also known to treat an oil flow at the sea bed in the separating of water, which is reinjected into the reservoir/formation in an immediately following operational step.

Known technique comprises i.a. NO B 152 730, NO B 166 145, NO C 173 838, NO 180 350 and U.S. Pat. No. 4,960,443.

Separators, in which gas and water are separated from the oil, form an essential component in such a sea-based processing plant, and with the purpose of guaranteeing savings, among other things, the separator(s) has (have) been placed on the sea bed in some cases. This is known from i.a. Norwegian patent document No. 173 838, in which several containers are placed on the sea bed with the purpose of separating oil and gas before further transport of these fluids in separate pipelines.

This known treatment of a hydrocarbon-based multiphase fluid is carried out in steps and comprises three or four separate phases.

Any water produced together with the oil, is separated from fluid and gaseous hydrocarbons in a first phase and can possibly be pumped back to the environment, i.e. into the sea, but because of the risk of contamination, it is often preferred instead to pump separated water back into the reservoir.

Gas separated from the oil in the sea bed separator is carried through a hose/pipeline to the surface and flared there. In these cases a flare tower with a burner does not necessarily have to be arranged on the production vessel, but rather on a separate buoy or similar floating structure in a surface position.

According to the Norwegian patent document No. 173 838 the oil is carried in a third phase to a tanker. The positioning of a separator(s) on the sea bed in this and similar connections is also generally known from U.S. Pat. Nos. 3,221,816, 3,556,218 and 3,608,630.

In accordance with the present invention the treatment/handling of crude oil with associated gas and possibly water, is implemented in a way and by a plant (system) that differ from the two main principles mentioned above, namely

(1) oil-gas-separation on surface level exclusively, or

(2) oil-gas-separation on sea bed level exclusively.

For said purpose the method and system according to the invention are characterized by the features appearing from the following independent claims.

According to the invention treatment of the well flow is carried out first on sea bed level and then in a surface position on board a sea-based vessel/platform/installation.

In a subsea part of the processing plant comprising, as the main component, at least one separator for oil:gas:water, a first non-completed separation or non-thorough separation of oil and gas is carried out according to the invention in such a way that the oil, which leaves this underwater separating process and is carried up to the surface vessel/platform contains a certain amount of gas, which is separated from the oil in a low-pressure plant aboard the ship/platform, i.e. in a surface position, the amount of gas carried in the oil and thus coming aboard the production vessel and, as mentioned already, being separated from the oil there in a low-pressure separator, is adjusted to the energy requirement for the operation of the total processing plant depending on supply of energy and comprising an underwater plant as well as a surface plant which can be driven by natural gas.

In practice it means that the separation accuracy of the sea bed separator is set (and/or pressure-adjusting measures are taken at sea bed level), so that it is ensured that an amount of gas will be carried aboard together with the oil within a defined period of time, which corresponds to the power consumption of the overall processing plant above and under water in said period of time.

Gas and water separated at the sea bed can be pumped back into the reservoir by means of subsea multiphase pumps.

As mentioned, water produced and some associated gas are separated in a subsea separator and returned to the reservoir, whereas in accordance with the present invention the rest of the gas is considered as an energy source for the operation of the plant, and is carried to the surface vessel together with the oil flow at low pressure—pressure on arrival topside is limited to e.g. 10 bar. As mentioned, the major part of the “intended” remaining gas is separated from the oil by means of a separate separator in a low-pressure plant on board the surface vessel. Here the last residue of water is also separated from the oil, for example in a centrifuge.

Ready-treated oil is transferred to storage tanks, whereas the gas separated on board the ship, is used as fuel for a power/effect generator, which can be arranged for operation of the subsea plant section of the processing plant and the plant section above water.

In practice, gas which might evaporate from the oil in the storage tanks of the ship/platform, could be used to generate power. Power-/effect-generating apparatus included in the above-water arrangement of the novel system, should not be integrated in the ship's/platform's other apparatus for power generation, but, on the contrary, form a separate independent machinery for the operation of a plant connected to the concerned treatment/handling of fluid hydrocarbons with associated gas and possibly containing water.

The amount of residual/consumption gas to be separated from the approximately predefined oil-gas-mixture aboard the surface vessel/platform is relatively small, and therefore auxiliary systems are required to a substantially smaller extent than if all separation was to be carried out in a surface position. The separator mounted on the surface can therefore be sized for a considerably lower pressure-class than normal, i.e. in known processing plants that have no separators on the sea bed, as the great pressures are taken care of in the subsea separator.

In the manner specified earlier, the residual gas is used for the generation of electric energy, i.e. as consumption gas, this so-called associated gas either being used directly as fuel for power generation, or the gas being used as fuel in a steam boiler which produces steam for a steam turbine connected to an electric generator.

Electric energy generated is used partly for the operation of subsea equipment, such as a separator for high-pressure conditions, multiphase pumps etc., partly for the operation of surface-based equipment, a small separator for low-pressure conditions etc.

The previously described method and system arranged in accordance with the present invention, assume that electric power is generated at all times by means of the associated gas transferred to the surface and separated there from the oil, to an extent sufficient for operating the plants included in the system for the handling of said fluid hydrocarbons with associated gas and possibly containing water. This requires in its turn that the system according to the invention is arranged adjustment-technically to allow control thereof, so that the necessary amount of gas for power generation is available at any time.

This control/adjustment can be implemented by setting and adjusting the separation conditions of the separator on the sea bed, so that the amount of gas separated is changed in the way desired, i.e. in accordance with the overall gas-based working power requirements of the system/the total processing plant, so that the oil transferred to the surface carries along an amount of associated gas, which is adjusted per time unit to the fuel requirement, or exceeds it to an insignificant degree.

Another possibility of control is to use a multiphase pump arranged in front of the separator on the sea bed. By changing the admission on this pump, the amount of well flow which is “drawn up” is controlled. Thereby the amount of well flow entering the separator will be changed, which brings about a change in the amount of oil with associated gas produced in the separation on the sea bed. By low separation pressure a pump may be installed downstream of the separator.

A combined above-water/underwater plant/system in accordance with the present invention can be constructed and adjusted according to the prevailing conditions on the field so that such handling of the produced hydrocarbons is allowed that emission of contaminated water or emission/flaring of exhaust gas can be avoided, if so dictated by the conditions. In practice the system may thus be arranged to work without exhaust gas, as all the gas produced is either used as fuel in processes connected to the system according to the invention, i.e. for the generation of power for the operation of the hydrocarbon handling plant as indicated in the foregoing, or is reinjected into the underground.

In the following description of an exemplary embodiment which represents a simplified system with a subsea plant section and a surface plant section, shown in a highly schematized representation in the figure in the appended drawing.

Reference is made to the figure representing a side view of the plant elements of the system, above and under the water surface 10.

The reference numeral 12 identifies a surface vessel in the form of a production ship, in the present invention forming a ship-based floating production system, whereas 14 identifies a shuttle tanker.

On the sea bed 16 is arranged a subsea first separator 18 (high-pressure separator) which receives an unprocessed well flow as suggested at 20.

As described earlier, this first separator 18 is formed, arranged, adapted and adjusted to subject the supplied well flow (at 20) to such a degree of separation that the oil flow delivered through a riser/hose 22 contains a predefined percentage of associated gas which is to cover the operation of the hydrocarbon processing plants, both above and under the sea surface 10.

Aboard the production ship 12 there is arranged a second step separator 24 for the separation of the residual gas/consumption gas and water carried in the oil up to the ship 12.

Reference numerals 28 and 30 identify a high-pressure swivel and an anchoring buoy, respectively; well-known components in connection with such ship-based oil production. 32 identifies mooring hawsers leading from the buoy 30 down to anchors (not shown) on the sea bed 16. This is to be understood only as an example of a possible anchoring system.

Unloading equipment aft on the production ship 12 is identified by 34. This also represents just an example of a possible unloading system.

The reference numeral 44 identifies a flare tower for possible flaring of excess gas, whereas 42 suggests placing of loading tank on board the production ship 12.

1. A method of sea-based handling of fluid hydrocarbons with associated gas and possibly containing water, wherein there is carried out at least one separation operation on the sea bed, in which gas is separated from oil, and in which hydrocarbons are carried by means of a riser (22) up to a surface vessel/production vessel (12), a platform or another sea-based installation, characterized in that an unprocessed well flow (at 20) on sea bed level (16) is subjected to a so-called controlled first separation step in a separator (18) installed on the sea bed, that the fluid hydrocarbons output from this separator (18) and carried up to said surface vessel (12) or platform through said riser (22), will contain an essentially predefined percentage of residual gas, which is separated from the fluid hydrocarbons on board said surface vessel (12) or platform in a second separation step in a separator (24) installed there, and that the separated residual gas is used as consumption gas/fuel for the operation of said subsea plant and said surface plant which serves to handle/treat said hydrocarbons.

2. A method as claimed in claim 1, characterized in that gas and possible water separated on sea bed level (16), and possible water and possible excess gas separated in the surface position, is/are returned to the reservoir (36, 38).

3. A method as claimed in claim 1 or 2, characterized in that residual gas separated on surface level and used as consumption gas, is used as fuel for the generation of electric power, which is used to drive components incorporated in the subsea plant, such as the first separator (18), multiphase pumps etc. and components incorporated in the surface plant, such as the second separator (24).

4. A method as claimed in claim 3, characterized in that the residual gas, such as consumption gas, separated from the oil in the surface position, is used as fuel in a gas turbine which is connected to a generator for the generation of electric energy.

5. A method as claimed in claim 3, characterized in that the residual gas, such as consumption gas, separated from the oil in the surface position, is used as fuel in a steam boiler which produces steam to be supplied to a steam turbine, which is connected to a generator for the generation of electric energy.

6. A method as claimed in claim 1, characterized in that the separating conditions in the first separation step on the sea bed are controlled/adjusted so that the percentage of separated gas is changed in a desired manner.

7. A method as claimed in claim 1, characterized in that the separating conditions in the first separation step on the sea bed is controlled/adjusted by changing the amount of well flow per time unit entering the separator (18) installed on the sea bed, so that the output rate of oil with associated gas from this separator (18) is changed.

8. A method as claimed in claim 1, characterized in that the arrival pressure on the surface is limited according to the conditions of the hydrocarbon flow at the sea bed.

9. A system for sea-based handling of fluid hydrocarbons with associated gas and possibly containing water, comprising at least one separator (18) installed on the sea bed, there receiving an unprocessed well flow, and there being arranged a riser (22) for the transfer of hydrocarbons output from this separator (18), to a surface vessel/production ship (12), a platform or another sea-based installation/structure incorporated in the system and exhibiting equipment for the treatment/handling and possibly temporary storing (42) of the oil, characterized in that the system's separator (18) installed on the sea bed is arranged to be controlled so that it outputs oil with an essentially predetermined percentage of associated residual gas, said oil containing residual gas being delivered through said riser (22) aboard said surface vessel/production ship (12), a platform or another sea-based installation/structure which is incorporated as mentioned in the system and is provided with a second separator (24) for the separation of the residual gas for use as consumption gas/fuel for the operation of the system plant, above water as well as under water, i.e. first and second separators (18 and 24) among other things.

10. A system as claimed in claim 9, characterized in that the surface plant of the system comprises a gas turbine which is arranged to allow input of said consumption gas as fuel in a gas turbine connected to a generator for the generation of electric power to be used for the operation of the system.

11. A system as claimed in claim 9, characterized in that the surface plant of the system comprises a steam boiler, which is arranged to receive, as fuel, residual/consumption gas in order thereby to produce steam as input to a steam turbine, which is connected to a generator for the generation of electric power to be used for the operation of the system.

12. A system as claimed in claim 11, characterized by devices for controlling/adjusting the separation conditions during the execution of the first separation step in the separator (18) installed on the sea bed, said device causing a change in the amount of well flow per time unit allowed to enter the inlet of this separator (18) in order thereby to adjust the gas separation rate of this separator.

13. A system as claimed in claim 11, characterized by a pump device incorporated in the subsea plant of the system and positioned upstream of the separator (18) installed on the sea bed, said pump device being arranged to cause—by a change of admission—a control/adjustment of the amount of well flow being “drawn up”, in order to change the amount of well flow passing into the separator.
